(19) United States
(12) Patent Application Publication
(10) Pub. No.: US 2018/0232938 A1
(43) Pub. Date: Aug. 16, 2018

(54) Method for Rendering Data, Computer Program Product, Display Device and Vehicle

(71) Applicant: Bayerische Motoren Werke Aktiengesellschaft, Muenchen (DE)

(72) Inventors: Violin YANEV, Muenchen (DE); Elias Marquart, Feldkirchen-Westerham (DE)

(21) Appl. No.: 15/950,893

(22) Filed: Apr. 11, 2018

Related U.S. Application Data
(63) Continuation of application No. PCT/EP2016/072655, filed on Sep. 23, 2016.

(30) Foreign Application Priority Data
Oct. 12, 2015 (DE) 10 2015 219 691.7

(51) Int. Cl. G06T 15/00; G06T 15/80; B60K 35/00; G06T 17/00

(52) U.S. Cl. CPC G06T 15/005; G06T 15/80; B60K 2350/352; G06T 17/005; B60K 35/00

(57) ABSTRACT

A method for rendering data of a display image for a display unit includes rendering the data of the display image using at least one shader unit, where the at least one shader unit is represented by an effect graph that has a structure and is representative of at least one graphical effect of the shader unit on the data of the display image as input data for generating output data. The method also includes adjusting, during the rendering, the shader unit dynamically and in real time by conditionally changing the structure and/or a topology of the effect graph based on a status of the display unit.

### CROSS REFERENCE TO RELATED APPLICATIONS

This application is a continuation of PCT International Application No. PCT/EP2016/072655, filed Sep. 23, 2016, which claims priority under 35 U.S.C. § 119 from German Patent Application No. 10 2015 219 691.7, filed Oct. 12, 2015, the entire disclosures of which are herein expressly incorporated by reference.

### BACKGROUND AND SUMMARY OF THE INVENTION

The present invention relates to a method for rendering data, a computer program product, a display unit and a vehicle. The present invention relates in particular to a method for rendering data of a display image for a display unit, a computer program product that can be used to execute the method, a display unit on the basis of the method and a vehicle, in particular a motor vehicle, having such a display unit.

Before data can be taken as a basis for producing a display image and displaying it on a display unit, the data on which the display image is based are, as part of a rendering method, which can also be referred to as image synthesis method, processed, conditioned and, on the basis of the respective application and particular control data, transformed into data that are then supplied to the display unit.

Part of the image synthesis is effected using what are known as shaders. The shaders are units that are present as software and/or hardware components and are present and run on a graphics unit, a graphics card or the like, for example.

A disadvantage of methods for rendering data of a display image for a display unit is that shaders conventionally used therein are firmly prescribed as source code and/or are tailored in advance to particular specific characteristics of the hardware used. Therefore, flexible configuration of the shader units has not been possible hitherto. Rather, there is already the obligation at the time of development to connect to the properties of the hardware used and configure the shader units accordingly.

It is therefore an object to specify a method for rendering data of a display image for a display unit in which there is a greater degree of flexibility for configuring the shader units to be used and in which, in particular while the rendering is still being executed, adjustments to the shader units to be used can be performed in real time.

According to a first aspect, the present invention provides a method for rendering data of a display image for a display unit, in which (A) the data of the display image are rendered by using at least one shader unit, (B) the at least one shader unit is represented by an effect graph (20), (C) the effect graph (i) has a structure and (ii) is representative of at least one graphical effect of the shader unit on the data of the display image as input data for generating output data, and (D) during the execution of the method the shader unit is adjusted dynamically and in real time by (E) conditionally changing the structure and/or the topology of the effect graph and/or possibly its subgraphs on the basis of a status of the display unit.

In contrast to the conventional approach, a shader unit to be taken as a starting point is thus not provided as firmly prescribed source code. Rather, according to the invention, an effect graph is prescribed that describes the flow of data and applicable operations on the data to attain a graphical effect and can still be altered before the shader unit is produced, so that conditionally changing the structure of the effect graph, in particular on the basis of a display unit to be used, means that shader unit to be derived from the effect graph is also adjustable dynamically and in real time as the effect graph changes.

As a result, a degree of flexibility is achieved that is higher according to the invention than is possible with conventional shader units firmly prescribed as source code.

In a preferred embodiment of the method according to the invention, there is provision for the step (B) of the shader unit being represented by the effect graph to involve (B-1) data representative of the effect graph being captured, possibly changed and stored, and (B-2) the shader unit being generated from the data representative of the effect graph. This means that the effect graph is prescribed in a particularly suitable manner by data that are representative of it, possibly is adjusted and then is stored so as then to generate the respective shader unit in due course from the stored data representative of the effect graph.

A particularly high degree of flexibility arises for the method according to the invention for rendering data of a display image if the step (E) of the structure and/or the topology of the effect graph and/or possibly its subgraphs being changed involves a structure of the effect of the effect graph being changed dynamically and in real time on the basis of a status of the display unit.

To achieve a greater degree of independence of the respective hardware resources for the conventional design of the method for rendering data of a display image, there is provision for the status of the display unit to be representative of properties of the display unit, in particular of display properties in regard to the display image. This means that, while the method for rendering is still being executed, the status of the respective display unit used can currently be attained as control data when generating the shader unit to be used by means of direct adjustment of the effect graph. This can relate to e.g. the resolution, the color space, the frame repetition rate, the size of the memory used, the bandwidth use on the display unit and the like.

The method according to the invention for rendering turns out to be particularly simple if the effect graph is a directional acyclic graph having a plurality of nodes and/or edges that in particular are or become associated with a value, in particular with input or output data, and/or with a processing process by the shader unit or a portion thereof for rendering. These measures result in a particularly simple structure, in particular with an explicit design without redundancy, for the effect graph used and the representative data on which it is based.

The method according to the invention for rendering data of a display image has various possible optimization options that can be taken on in advance in the planning phase or else while the method is still being executed and, depending on the situation, in real time.

For example, according to a preferred embodiment of the method according to the invention, there is provision for a plurality of data records and in particular texture data records to be combined in a data atlas and in particular texture atlas, and, in particular, conveyed by the step (D) of the shader unit being adjusted, a suitable data record or texture data record for rendering to be selected and/or an unsuitable data record or texture data record to be removed from the data or texture atlas. These measures can each be used currently, that is to say while the method is being executed, to decide whether particular data records or texture data records can be used or rejected in connection with the requirements of the display unit used. Such optimization decreases e.g. the expenditure of data to be carried and can be applied not only to texture data but also other data.

A data atlas or texture atlas acts as an amalgamation of multiple data buffers that, e.g. depending on the display unit, can have a higher or lower render speed. A texture atlas is an example of a data atlas.

In another embodiment of the method according to the invention, the status of the display unit is taken as a basis for input data, in particular of the shader unit, being checked and/or adjusted in regard to a data format.

Another embodiment of the method according to the invention for rendering data of a display image is made particularly effective by virtue of the status of the display unit being taken as a basis for a plurality of mesh data records being assembled and, in particular, effect graphs for assembled mesh data records being combined to form a joint effect graph.

Conventional methods for rendering data of a display image frequently involve there being a great deal of complexity for recomputing particular data. This complexity can be reduced according to the invention by virtue of a check being performed to determine whether and/or how frequently input data of the effect graph and/or subgraphs of the effect graph are changed per se, and, in particular, input data and/or subgraphs that do not change or do not change more frequently than to a particular extent are computed or determined differently, possibly a single time and/or in lossy fashion, and buffer-stored for further use.

According to a further aspect of the present invention, a computer program product is provided that has a program code that, when executed on a computer or a digital signal processing device, prompts the computer or the device to execute the method according to the invention for rendering data of a display image for a display unit.

Preferably, the computer program product according to the invention has a nonvolatile storage medium, for example a CD-ROM, a DVD-ROM, an SSD unit or the like.

The present invention further provides a display unit that has a control unit that is set up to execute, during operation, a method according to the invention for rendering data of a display image for a display unit.

Moreover, the present provides a vehicle, in particular a motor vehicle, that has a display unit according to the invention.

Other objects, advantages and novel features of the present invention will become apparent from the following detailed description of one or more preferred embodiments when considered in conjunction with the accompanying drawings.

### BRIEF DESCRIPTION OF THE DRAWINGS

Further details, features and advantages of the invention will emerge from the description below and the figures, in which:

FIG. 1 shows is a block diagram that shows, in schematic form, a display method using an embodiment of the method according to the invention for rendering data of a display image.

FIG. 2 is a schematic block diagram that shows a preferred embodiment of the method according to the invention for rendering data of a display image.

FIG. 3 shows, in the form of a schematic block diagram, details of another embodiment of the method according to the invention for rendering data of a display image with the focus on the generation of a shader unit.

FIG. 4 shows, in the form of a schematic block diagram, the design of an effect graph on which a shader unit is based.

FIG. 5 shows a vehicle according to the invention using a display unit according to the invention.

### DETAILED DESCRIPTION OF THE DRAWINGS

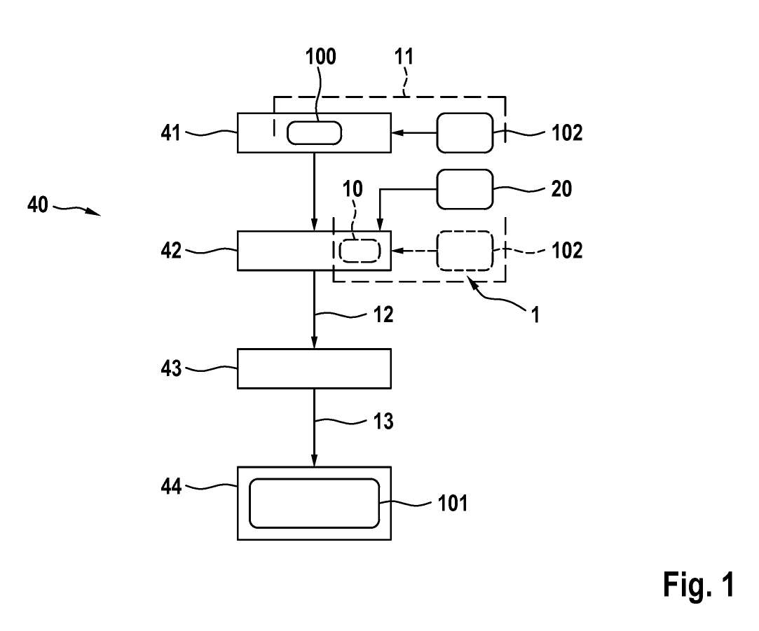

Exemplary embodiments of the invention are described in detail below with reference to FIGS. 1 to 5. Like and equivalent elements and components and also elements and components having like or equivalent effects are denoted by the same reference symbols. The detailed description of the denoted elements and components is not repeated in each case in which they occur.

The depicted features and further properties can be combined in any form in isolation from one another and arbitrarily with one another without departing from the essence of the invention.

FIG. 1 uses the style of a schematic block diagram to show a method 40 for processing and displaying data 100 of a display image 101 to be displayed for a display unit 50, in which an embodiment of the method 1 according to the invention for rendering the data 100 of the display image 101 for the display unit 50 is used. The method 40 for processing and displaying the data 100 of the display image 101 can be regarded as what is known as a graphics pipeline.

The graphics pipeline of the method 40 shown in FIG. 1 consists, in essence, of an application unit 41, a geometry unit 42, a raster unit 43 and a presentation unit 44.

The application unit 41 of the processing and display method 40 provides the fundamental processes that generate the data 100 on which the image 101 to be displayed is based for the display unit 50. This may be a standard application program, e.g. as part of a multimedia or navigation system in a vehicle.

The geometry unit 42 is used for the geometric conditioning of the underlying data 100 in regard to the display image 101 to be displayed, possibly using control data 102, which can also describe display parameters of the underlying display unit 50, for example. The data 100 for the display image 101 and the control parameters 102 therefore form the input data 11 for the geometry unit 42.

The geometry unit 42 contains provision for at least one embodiment of the method 1 according to the invention for rendering the data 100 of the display image 101 for the display unit 50. That is to say that at least one shader unit 10 is used that is represented by an effect graph 20. Using the at least one shader unit 10, which is adjustable dynamically and in real time, possibly using the control data 102, by means of a change in the effect graph 20, a large portion of the geometric method steps for producing the display image 101 from the underlying data 100 is executed in the geometry unit 42. This relates in particular, but possibly not only, to aspects of model and camera transformations, the lighting, the projection, the tailoring of the applicable image detail in the sense of clipping and the applicable coordinate transformations to the display area of the display unit.

In this context, it is also possible for different shader units 10 to take effect, which are then each represented, according to the invention, by a respective effect graph 20.

This is then followed by the raster unit 43, which is used to convert the generated data and in particular the primitives generated in the process into discrete fragments.

The presentation unit 44 is subsequently used to depict the display image 101 on the basis of the—possibly adjusted—data 100 on an associated display unit 50.

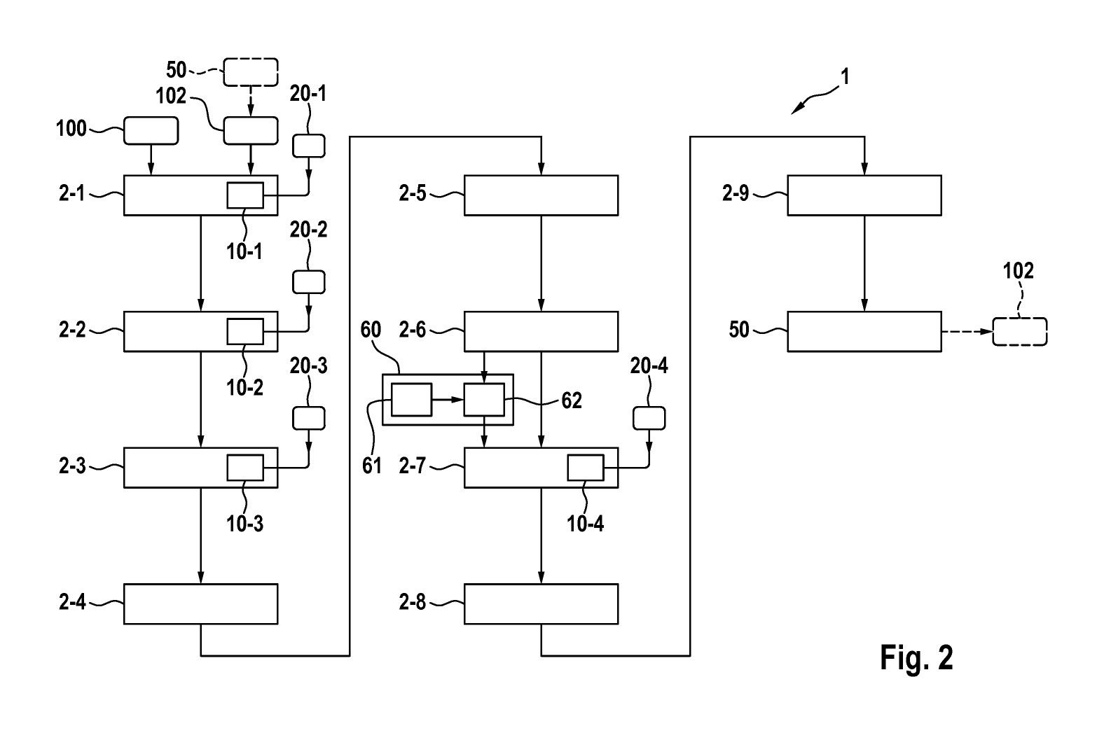

FIG. 2 uses a block diagram in schematic form to show a method 1 according to the invention for rendering data 100 of a display image 101 for a display unit 50, as may be designed in connection with a geometry unit 42 as shown in FIG. 1.

This embodiment of the method 1 according to the invention for rendering data 100 takes the data 100 on which the image 101 to be displayed is based, for example a set of three-dimensional coordinates or the like, and takes appropriately supplied control data 102, which may also be representative of properties of the underlying display unit 50, as a basis for performing a transformation by means of a transformation unit 2-1. In this case, a first shader unit 10-1, for example a vertex shader, can take effect, which is derived from a first effect graph 20-1.

This is followed by a tessellation unit 2-2, which uses a second shader unit 10-2 to derive a tessellation of the scene from a second effect graph 20-2. This second shader 10-2 is therefore also referred to as a tessellation shader.

This is followed by a geometry unit 2-3, which is based on a third shader 10-3 and a third effect graph 20-3. The third shader unit 10-3 is also referred to as a geometry shader.

This is then followed by units 2-4 to 2-6 for perspective transformation, detail trimming and rasterization. The result obtained from the raster unit 2-6 is primitives, for example triangles, but more generally simplices, that provide the primitives for the pixels with an applicable texture e.g. by means of a texture atlas 60 using a texture cache 61 and a texture filter 62 in the subsequent pixel unit 2-7 using a fourth shader unit 10-4, e.g. a pixel shader, on the basis of a fourth effect graph 20-4.

This is followed by an overlay and smoothing unit 2-8 for image composition and/or edge smoothing and a post-processing unit 2-9, before the display data 13 obtained in this manner are supplied to the display unit 50 for display from the method 1 for rendering the data 100 on which the display image 101 is based.

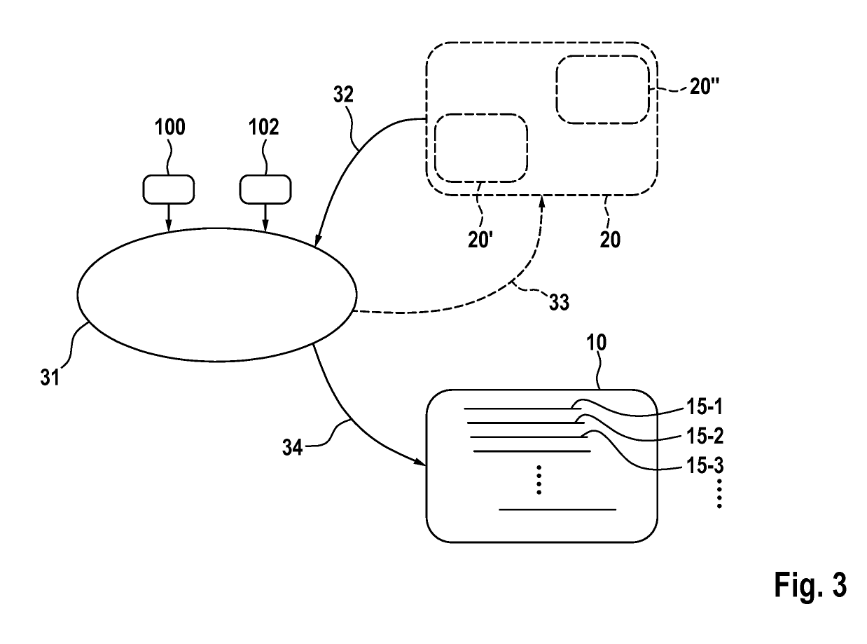

FIG. 3 uses the style of a block diagram to show, in schematic form, an embodiment pertaining to the deriving, according to the invention, of a shader unit 10 from an underlying effect graph 20.

The starting point is an initial effect graph 20, which in this case can consist of two subgraphs 21 and 22. The effect graph 20 is supplied together with the underlying data 100 for the image 101 to be displayed and with control data 102, which can describe the status of the underlying display unit 50, for example, to a construction unit 31 in a step 32 in order to form individual shader instructions 15-1, 15-2, 15-3, . . . therefrom in current form for the shader that is to be constructed.

On the other hand, the control data 102 can also be taken as a basis for changing the basic structure of the initial effect graph 20 and its subgraphs 20-1 and 20-2 in a step 33 so as to adjust the effect graph 20, and therefore a structure to be used for the shader 10 in future, which is derived from the structure of the effect graph 20 in its respective current form, of course, in a dynamic manner.

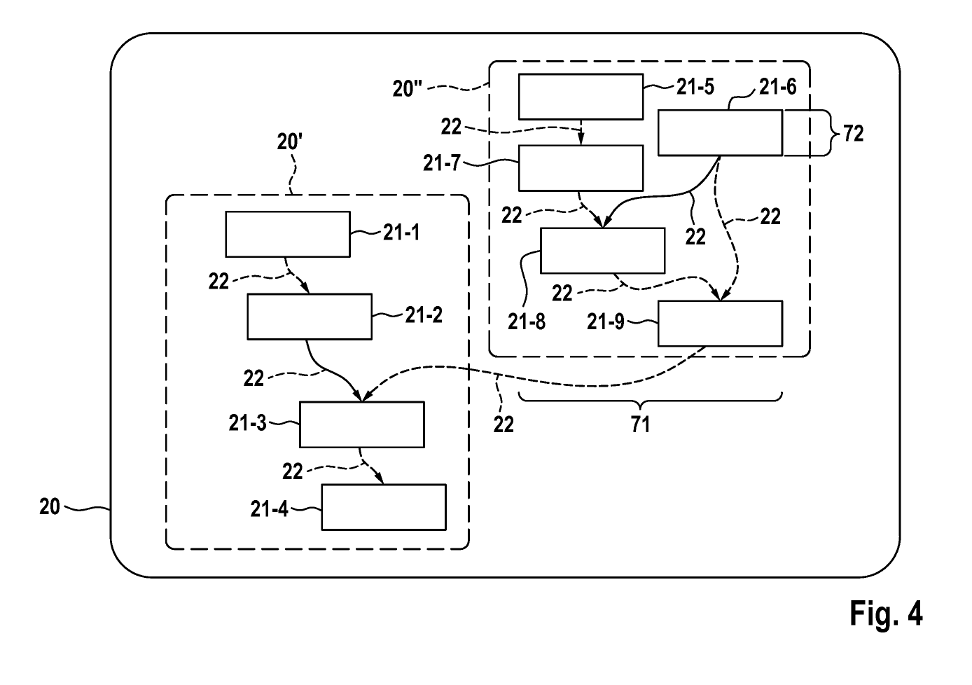

FIG. 4 uses the style of a block diagram to show, in schematic form, a possible design of an effect graph 20 for representing a shader unit 10 according to the present invention.

The effect graph 20 shown in FIG. 4 is an effect graph 20 overlayable from two subgraphs 20-1 and 20-2. In this case, the first subgraph 20-1 is a nonstatic subgraph, consisting of an input node 21-1 and a plurality of operational nodes 21-2, 21-3, 21-4, . . . , which are connected to one another by edges 22. Since the input node 21-1 with its input data may be variable, the subgraph 20-1 is variable, that is to say not static, overall. It is subject to changes that render buffer-storage in the sense of caching pointless.

By contrast, the second subgraph 20-2 is provided with data nodes 21-5 and 21-6 having constant input data, for example vertex or texture attributes, which do not change. Moreover, the operational nodes 21-7, 21-8 and 21-9 and also the associated edges 22 are also invariable. Therefore, the structure of the second subgraph 22-2 of the effect graph 20 and the underlying data can be buffer-stored, for example in a cache memory, so that this decreases the computation complexity for this embodiment of the method 1 according to the invention for rendering data 100 of a display image 101 to be displayed.

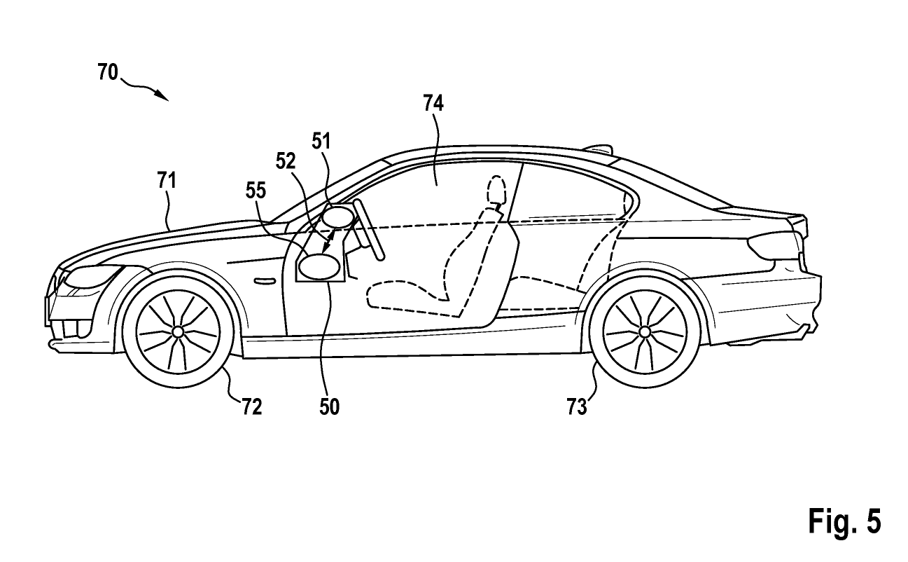

FIG. 5 shows a schematic side view of an embodiment of a vehicle according to the invention in which a display unit 50 according to the present invention can be used.

The vehicle 70 depicted in FIG. 5 is a motor vehicle having a bodywork 71 and wheels 72 and 73 mounted thereon. Inside 74 the bodywork 71, the embodiment of the display unit 50 according to the invention is formed in the front area of the vehicle 70. The display unit 50 comprises a display means 51 for displaying a display image 101 and also a control unit 55 that is connected to the display device 51 via a control line 52 and displays the display image 101 as appropriate on the basis of an embodiment of the method 1 according to the invention for rendering data 100 of the display image 101.

The display unit 50 may be a navigation appliance, a multimedia unit or a portion thereof, for example.

These and further features and properties of the present invention are explained further using the descriptions below:

A shader unit within the context of the invention, which can also be referred to as a GPU shader, is a program that is executed in the GPU, that is to say the processor of the graphics card. A GPU shader can consist e.g. of three shader units within the context of the present invention, namely a vertex shader, a geometry shader and a pixel shader.

The vertex shader is executed for each vertex. The input it receives is corners and relevant parameters of a vertex, such as the normal thereof and a texture coordinate, for example, and also further global parameters. From these statements, the vertex shader generates simple three-dimensional objects, what are known as primitives. Moreover, the vertex shader performs further preliminary computations, such as ascertainment of the vertex color, transformation of the vectors into coordinate systems and generation of texture coordinates, for example.

In the case of certain graphics pipelines—e.g. including in the case of Direct-3D 9.0, a standard for graphics cards—the output of a vertex shader is transferred directly to a raster unit that breaks down the primitives into pixels.

For each rastered point, the pixel shader is executed. The pixel shader assigns each pixel certain attributes, such as a color value and lighting effects, for example.

The shader model 4 and e.g. also the Direct-3D standard introduced a new element into the graphics pipeline, the geometry shader. The geometry shader is executed directly after the vertex shader and before rasterization. Whereas the vertex shader can only ever process one vertex after the other, the geometry shader is capable of processing all vertexes belonging to a primitive at the same time. Furthermore, the geometry shader can replicate primitives and change their size. The output it produces is again primitives.

For programming shaders, there are three high-level languages: GLSL, HLSL and NVidia.

Within the context of the present invention, the terms “graphical effect” and “shader” can be used synonymously, but the essence is that shaders are generated from an underlying effect graph.

Instead of a shader, there is now initially an effect graph for producing visual effects. The effect graph, as a directed acyclic graph, describes the flow of data and which data are computed from which other data by means of which operations. From a given effect graph, a shader becomes generable, specifically such that a change in the effect graph results in a corresponding change in the shader unit.

It is disadvantageous that shaders have hitherto needed to take into consideration characteristics of the hardware to be used beforehand. Shaders are therefore often very complex because they are optimized for this hardware. Conventional shaders are atomic and dependencies between shaders are firmly prescribed (“hard coded”). Waiting times or data conflicts can arise during operation. At the time of development of a shader unit, it has hitherto been necessary to know for which hardware the shader unit is developed.

Effect graphs 20 can be used to perform optimizations on shader units 10 that would not be possible solely with conventional shaders on a source code basis. There are, inter alia, two classes of optimizations:

(a) Optimizations that are possible at the time of development. In the effect graph depiction of a shader, these optimizations can also be executed at runtime.
(b) Optimizations that are possible only at runtime. Inter alia, data can be computed or determined in advance, possibly with a loss of quality, but with a higher level of performance in return.

For (a), there are, inter alia, methods based on a texture atlas. A texture atlas is computed dynamically, effectively as a combination of multiple textures. This involves multiple textures being combined in one texture. It is then possible to dynamically decide, depending on the hardware, which components of the atlas are used or else eliminated. That is to say that the system can, according to the invention, take the effect graph as a basis, and therefore use the shader, to decide which texture can be used to attain a better/faster result. The respective method is then employed on the basis of the display means used.

Further, there is the possibility of optimizing shader inputs, specifically depending on which format for the hardware works fastest, e.g. by using three float variables instead of a float array with the magnitude 3.

Moreover, there is the possibility of merging or assembling meshes, which can sometimes lead to a performance increase. On the basis of specific parameters of the hardware, a decision is made as to whether and which meshes can be assembled. In this case, the effect graphs of assembled meshes are then, according to the invention, also likewise assembled.

For (b), there are the following methods, inter alia:

A shader unit according to the invention that has a component that is static—i.e. the data do not change or do not change often—can be split such that the static component is determined or computed only once, but possibly in lossy fashion, or only if the input data change. This allows computation time to be saved, in particular if the static computations are comparatively complex.

It is important for optimizations to be applicable at runtime because they can influence one another. The application of an optimization is a dynamic event on the basis of which a decision can be made regarding the application or nonapplication of other optimizations.

It is possible e.g. to use a texture atlas and the merging of meshes at the same time. In this case, it is sometimes possible for a scene having many meshes and many textures to be converted to a single mesh having one texture, which saves GPU time.

In contrast to conventional atomic shaders, shader units generated from effect graphs are automatically configured such that their dependencies are fulfilled—e.g. if a shader B needs data from a shader A, shader A is executed first of all—without the developer explicitly needing to worry about the dependency.

In effect graphs, it is possible—even if certain features are not available at the time of development—for these features to be substituted with equivalent features.

### LIST OF REFERENCE SYMBOLS

1 Method for rendering data
2-1 Transformation unit
2-2 Tessellation unit
2-3 Geometry unit
2-4 Perspective transformation unit
2-5 Detail trimming unit
2-6 Raster unit
2-7 Pixel unit
2-8 Overlay and smoothing unit, image composition/edge smoothing unit
2-9 Post-processing unit
10 Shader unit
10-1 Shader unit, vertex shader
10-2 Shader unit, tessellation shader
10-3 Shader unit, geometry shader
10-4 Shader unit, pixel shader
11 Input data
12 Output data
13 Display data
15-1 Shader instruction
15-2 Shader instruction
15-3 Shader instruction
20 Effect graph
20′ Subgraph, dynamic
20″ Subgraph, static
20-1 First effect graph
20-2 Second effect graph
20-3 Third effect graph
20-4 Fourth effect graph
21-1 Input node, input node of the effect graph 20
21-2 Operational node of the effect graph 20
21-3 Operational node of the effect graph 20
21-4 Operational node of the effect graph 20
21-5 Data node of the effect graph 20
21-6 Data node of the effect graph 20
21-7 Operational node of the effect graph 20
21-8 Operational node of the effect graph 20
21-9 Operational node
22 Edge of the effect graph 20
31 Construction unit
32 Step of supplying
33 Step of changing
34 Step of producing shader instructions 15-1, 15-2, . . .
40 Method for processing and displaying data
41 Application unit
42 Geometry unit
43 Raster unit
44 Presentation unit
50 Display unit
51 Display means
52 Control line
55 Control unit
60 Data atlas, texture atlas
61 Data cache, texture cache
62 Data filter, texture filter
70 Vehicle
71 Bodywork
72 Wheel
73 Wheel
74 Inside of the vehicle 70
100 Underlying data for the display image 101
101 Display image
102 Control data

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for rendering data of a display image for a display unit, the method comprising the acts of:
rendering the data of the display image using at least one shader unit, wherein the at least one shader unit is represented by an effect graph that has a structure and is representative of at least one graphical effect of the shader unit on the data of the display image as input data for generating output data; and
adjusting, during said rendering, the shader unit dynamically and in real time by conditionally changing the structure and/or a topology of the effect graph based on a status of the display unit.

2. The method as claimed in claim 1, further comprising the acts of:
capturing data representative of the effect graph; and
generating the shader unit from the data representative of the effect graph.

3. The method as claimed in claim 1,
wherein conditionally changing the structure and/or the topology of the effect graph based on the status of the display unit comprises changing a structure of the at least one graphical effect dynamically and in real time based on the status of the display unit.

4. The method as claimed in claim 2,
wherein conditionally changing the structure and/or the topology of the effect graph based on the status of the display unit comprises changing a structure of the at least one graphical effect dynamically and in real time based on the status of the display unit.

5. The method as claimed in claim 1, wherein the status of the display unit is representative of properties of the display unit in regard to the display image.

6. The method as claimed in claim 1,
wherein the effect graph is a directional acyclic graph having a plurality of nodes and/or edges that are associated with at least one of input data, output data, and a rendering process of at least a portion of the shader unit.

7. The method as claimed in claim 2,
wherein the effect graph is a directional acyclic graph having a plurality of nodes and/or edges that are associated with at least one of input data, output data, and a rendering process of at least a portion of the shader unit.

8. The method as claimed in claim 3,
wherein the effect graph is a directional acyclic graph having a plurality of nodes and/or edges that are associated with at least one of input data, output data, and a rendering process of at least a portion of the shader unit.

9. The method as claimed in claim 1, further comprising:
combining a plurality of texture data records in a texture atlas, and
wherein adjusting the shader unit comprises at least one of selecting a suitable texture data record for rendering and removing an unsuitable texture data record is removed from the texture atlas.

10. The method as claimed in claim 2, further comprising:
combining a plurality of texture data records in a texture atlas, and
wherein adjusting the shader unit comprises at least one of selecting a suitable texture data record for rendering and removing an unsuitable texture data record is removed from the texture atlas.

11. The method as claimed in claim 3, further comprising:
combining a plurality of texture data records in a texture atlas, and
wherein adjusting the shader unit comprises at least one of selecting a suitable texture data record for rendering and removing an unsuitable texture data record is removed from the texture atlas.

12. The method as claimed in claim 1, wherein the status of the display unit is based on input data of the shader unit being checked and/or adjusted in regard to a data format.

13. The method as claimed in claim 1, wherein the status of the display unit is based on a plurality of mesh data records being assembled, and wherein the method further comprises combining effect graphs for the assembled mesh data records to form a joint effect graph.

14. The method as claimed in claim 1, further comprising:
performing a check to determine whether and/or how frequently input data and/or subgraphs of the effect graph are changed, and
wherein input data and/or subgraphs that do not change or do not change more frequently than to a particular extent are computed and buffer stored for further use.

15. A display unit configured to display a display image and comprising a control unit that is configured to:
render data of the display image using at least one shader unit, wherein the at least one shader unit is represented by an effect graph that has a structure and is representative of at least one graphical effect of the shader unit on the data of the display image as input data for generating output data; and
adjust, during said rendering, the shader unit dynamically and in real time by conditionally changing the structure and/or a topology of the effect graph based on a status of the display unit.

16. A vehicle comprising a display unit, wherein the display unit is configured to display a display image, and where in the display unit comprises a control unit that is configured to:
render data of the display image using at least one shader unit, wherein the at least one shader unit is represented by an effect graph that has a structure and is representative of at least one graphical effect of the shader unit on the data of the display image as input data for generating output data; and
adjust, during said rendering, the shader unit dynamically and in real time by conditionally changing the structure and/or a topology of the effect graph based on a status of the display unit.
